(19) United States
(12) Patent Application Publication
(10) Pub. No.: US 2007/0040996 A1
(43) Pub. Date: Feb. 22, 2007

(54) PROJECTOR AND BEAM SPLITTER THEREOF

(76) Inventors: Ho Lu, Hsin-Chu Hsien (TW); Po Liang Chiang, Taipei City (TW); Chao-Hsuan Huang, Yun-Lin Hsien (TW); Yi Wei Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/465,453

(22) Filed: Aug. 18, 2006

Related U.S. Application Data
(60) Provisional application No. 60/595,973, filed on Aug. 22, 2005.

(51) Int. Cl. G03B 21/14; H04N 9/12

(52) U.S. Cl. 353/84; 348/742

(57) ABSTRACT

A projector includes an invisible light addressing unit, a light synthesizing plane, a visible light valve, and a projection lens. The invisible light addressing unit includes a sequentially-controlled light shifter able to generate a plurality of addressed invisible sub beams sequentially. The visible light valve can be turned on by the addressed invisible sub beams to allow a visible light source to go through, thereby generating a plurality of visible beams.

### CROSS REFERENCE TO RELATED APPLICATIONS

This application claims priority from U.S. provisional application No. 60/595,973, filed Aug. 22, 2005, entitled “Single visible light valve projector controlled by an invisible light valve”.

### BACKGROUND OF THE INVENTION

1. Field of the Invention

The present invention relates to a projector and a beam splitter thereof, and more particularly, to a projector that uses an invisible light valve to control a visible light valve so as to allow visible light source to penetrate through the visible light valve.

2. Description of the Prior Art

As the requirement for large size displays increases, projectors become more and more popular. A projector is a device that optically projects images to a large size screen. Currently, projectors can be classified into two types. The first type of projector requires a light separating unit to project beams of different colors to different light valves, and a light synthesizing unit to synthesize beams emitted from different light valves. The first type of projector such as LCOS projector or LCD projector, requires sophisticated light separating unit and light synthesizing unit, and thus size and cost are not easy to reduce. The second type of projector uses a sequentially-controlled device, e.g. a color wheel, to project beams of different colors to a light valve at different time points, thereby combining the beams of different colors. The images are displayed due to persistence of vision. The second type of projector such as DLP projector has two main disadvantages. First, the speed of the light valve and sequentially-control device must be very fast to fulfill the requirement for persistence of vision, and this increases manufacturing difficulties. Second, the persistence of vision phenomenon varies from person to person, or even varies with viewer's physical condition when viewing. Therefore, the rainbow phenomenon happens to some viewers, and this deteriorates display quality.

In addition, laser source has the advantages of high saturation, durability, and low operation temperature, etc., and is expected to replace the mercury lamp that has high pressure and high temperature limitations. However, current laser source has some limitations in applications. For instance, laser is a high coherent light source, and this results in speckling issue.

### SUMMARY OF THE INVENTION

It is therefore one of the objectives of the present invention to provide a projector and a beam splitter thereof to improve the quality of display and light source.

According to one embodiment of the present invention, a projector is provided. The projector includes an invisible light addressing unit, a visible light generator, a light synthesizing plane, a visible light valve, and a projection lens. The invisible light addressing unit includes an invisible light generator for generating an invisible light source, an invisible light valve for receiving the invisible light source and transforming the invisible light source into an addressed invisible beam, a sequentially-controlled light shifter for receiving the addressed invisible beam and sequentially transforming the addressed invisible beam into a plurality of addressed invisible sub beams, and an image formation unit for forming images of the addressed invisible sub beams. The visible light generator is for generating a visible light source. The light synthesizing plane is for receiving the addressed invisible sub beams sequentially and the visible light source, and sequentially synthesizing the addressed invisible sub beams and the visible light source. The visible light valve is for receiving the addressed invisible sub beams and the visible light source, and the visible light valve includes a plurality of pixel regions. Each pixel region has a plurality of sub-pixel regions, and each sub-pixel region of each pixel region is able to be turned on by each addressed invisible sub beams, so as to allow the visible light source to penetrate through and sequentially form a plurality of visible beams. The projection lens is for projecting the visible beams.

According to another embodiment of the present invention, a beam splitter is provided. The beam splitter includes a light source generator for generating a light source, and a sequentially-controlled light shifter including a plurality of regions. The sequentially-controlled light shifter is movable so that the light source sequentially penetrates through different regions and the light source is transformed into a plurality of beams with different shifts.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 schematically illustrates a projector according to a preferred embodiment of the present invention.

FIG. 2 schematically illustrates an invisible light addressing unit.

FIG. 3 illustrates a sequentially-controlled light shifter of the present invention.

FIG. 4 is a schematic diagram of a sequentially-controlled light shifter in accordance with another embodiment of the present invention.

FIG. 5 is a schematic diagram of a visible light valve.

FIGS. 6 and 7 schematically illustrate projectors according to other embodiments of the present invention.

FIG. 8 illustrates the sequentially-controlled light shifter when serving as a beam splitter.

FIG. 9 is a intensity vs. position relation chart.

### DETAILED DESCRIPTION

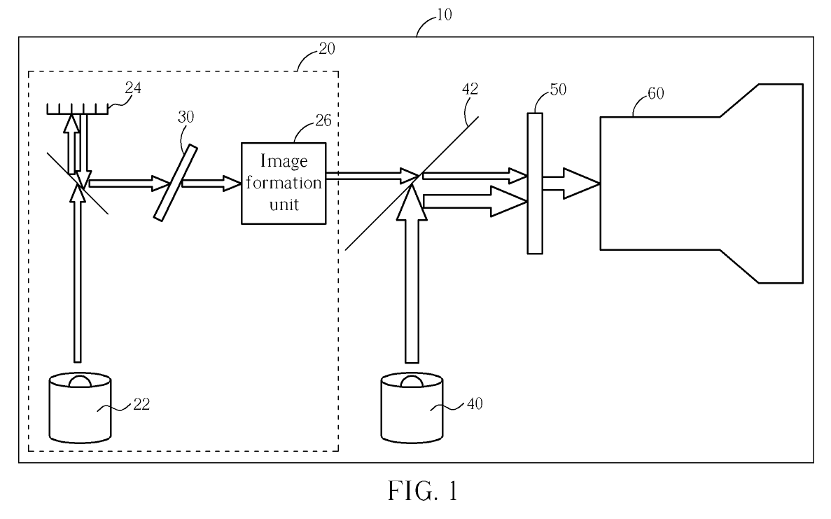

Refer to FIG. 1. FIG. 1 schematically illustrates a projector according to a preferred embodiment of the present invention. As shown in FIG. 1, the projector 10 of this embodiment includes an invisible light addressing unit 20, a visible light generator 40, a light synthesizing plane 42, a visible light valve 50, and a projection lens 60. The invisible light addressing unit 20 includes an invisible light generator 22, an invisible light valve 24, a sequentially-controlled light shifter 30, and an image formation unit 26. The invisible light generator 22 is used to generate a light source having a wavelength beyond the wavelength range of visible light (430 to 650 nm). The invisible light valve 24 is able to receive the invisible light source, and transform the invisible light source into an addressed invisible beam. The sequentially-controlled light shifter 30 is used to receive the addressed invisible beam, and sequentially transform the addressed invisible beam into a plurality of addressed invisible sub beams. The images of the addressed invisible sub beams are formed on the visible light valve 50 by the image formation unit 26.

The visible light generator 40 is used to constantly generate a visible light source having a wavelength within the wavelength range of visible light. This visible light source will go toward the light synthesizing plane 42, and be reflected to the visible light valve 50 by the light synthesizing plane 42. On the other hand, the addressed invisible sub beams will penetrate through the light synthesizing plane 42, and strike the visible light valve 50. The feature of the visible light valve 50 of the present invention is that the visible light valve 50 can be turned on by the addressed invisible sub beams, so as to allow the visible light source to penetrate through. The penetrating visible light source will then enter the projection lens 60, thereby projecting images.

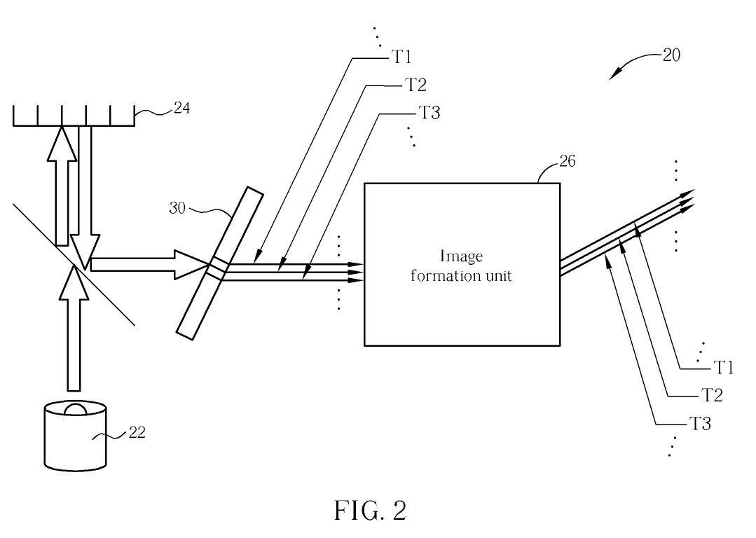

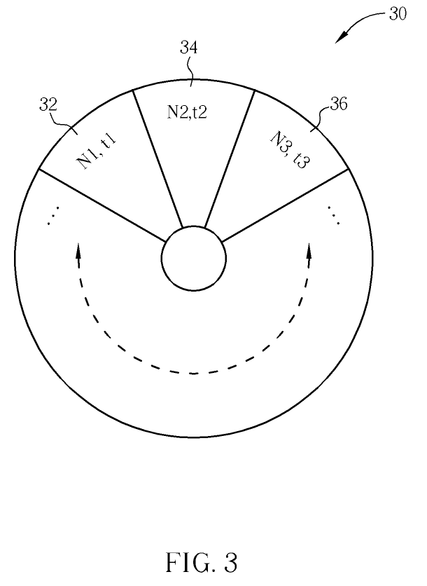

Refer to FIG. 2 and FIG. 3 in conjunction with FIG. 1. FIG. 2 schematically illustrates an invisible light addressing unit, and FIG. 3 illustrates a sequentially-controlled light shifter of the present invention. As shown in FIG. 2, the invisible light generator 22 can generate an invisible light source e.g. IR source or UV source, and the invisible light valve 24 can convert the invisible light source into an addressed invisible beam. In this embodiment, the invisible light valve 24 is a light-modulating device such as a digital micromirror device (DMD) chip, an LCOS panel, or an LCD panel. The incident invisible light source can be modulated by the invisible light valve 24, and transformed into an addressed invisible beam. It is appreciated that if a DMD chip is selected as the invisible light valve 24, the gray scale of the image to be displayed is controlled by the lasting time of the addressed invisible beam. If the invisible light valve 24 is an LCOS panel or an LCD panel, the gray scale is controlled by the intensity of the addressed invisible beam. When the addressed invisible beam enters the sequentially-controlled light shifter 30, the addressed invisible beam will be converted into a plurality of addressed invisible sub beams.

The operation of the sequentially-controlled light shifter 30 is illustrated in FIG. 3. The sequentially-controlled light shifter 30 of this embodiment, made of transparent material e.g. glass, includes a plurality of regions 32, 34, 36, and the regions 32, 34, 36 have different refraction indexes (N1, N2, N3) and/or different thicknesses (t1, t2, t3). The sequentially-controlled light shifter 30 is equipped non-vertically with respect to the optical axis of the addressed invisible beam, and the sequentially-controlled light shifter 30 can be moved rotatably. According to Snell's law, when a beam passes through a dielectric, the incident beam and the outgoing beam will be parallel. The outgoing beam is shifted from the incident beam, and the shifting gap is related to the refraction index and the thickness of the dielectric. Accordingly, when the sequentially-controlled light shifter 30 rotates, the addressed invisible beam will penetrates through the regions 32, 34, 36 at different time points. Therefore, a plurality of addressed invisible sub beams T1, T2, T3 can be generated sequentially.

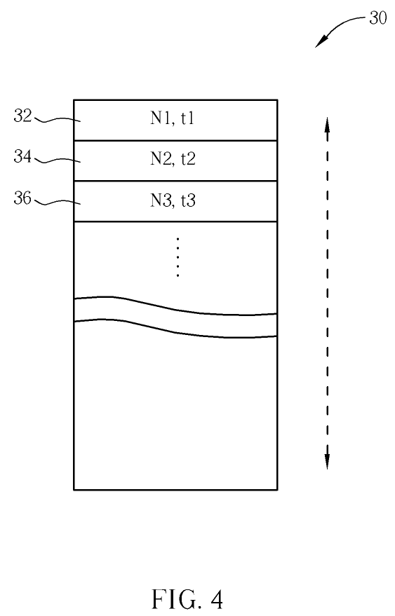

The sequentially-controlled light shifter 30 is not limited to move rotatably. Refer to FIG. 4. FIG. 4 is a schematic diagram of a sequentially-controlled light shifter 30 in accordance with another embodiment of the present invention. As shown in FIG. 4, the sequentially-controlled light shifter 30 moves to and fro, instead of rotatably. The addressed invisible beam will penetrate through the regions 32, 34, 36 at different time points, and therefore sequentially form a plurality of addressed invisible sub beams T1, T2, T3.

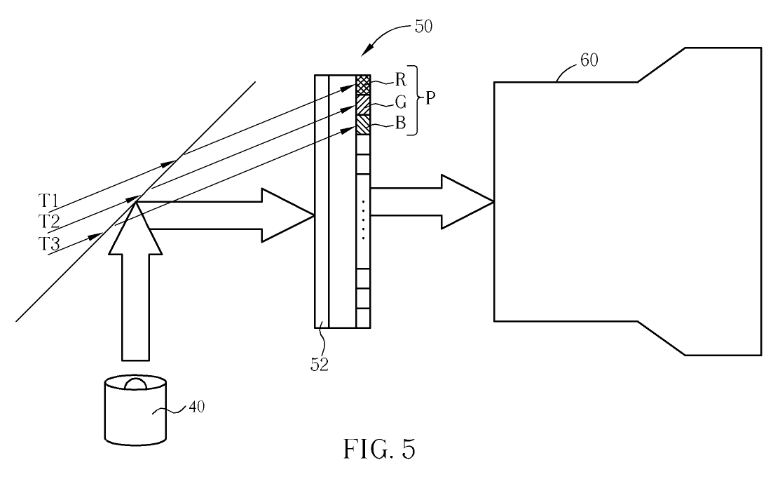

Refer to FIG. 5 and FIG. 1. FIG. 5 is a schematic diagram of a visible light valve. As shown in FIG. 5, the visible light valve 50 can be an LCD panel, but not limited. The visible light valve 50 includes a plurality of pixel regions P, and each pixel region P includes a plurality of sub-pixel regions R, G, B with different color coatings therein. The visible light valve 50 further includes an opto-electronic device layer 52 having opto-electronic devices such as photodiode or CCD corresponding to the sub-pixel regions R, G, B. The opto-electronic device can be turned on by irradiation of invisible light. When the sub-pixel regions R, G, B of each pixel region P respectively receive the addressed invisible sub beams T1, T2, T3, the opto-electronic devices will turn on the sub-pixel regions R, G, B in order. Accordingly, the visible light source can penetrate through the turned-on sub-pixel regions R, G, B, thereby generating a plurality of visible beams sequentially. These visible beams will be projected by the projection lens 60. In this embodiment, each pixel is composed of a red sub-pixel, a green sub-pixel, and a blue sub-pixel, and thus the amount of the addressed invisible sub beams is set to 3. If each pixel comprises more sub-pixels such as 4 sub-pixels or 6 sub-pixels, the amount of the addressed invisible sub beams should be modified correspondingly.

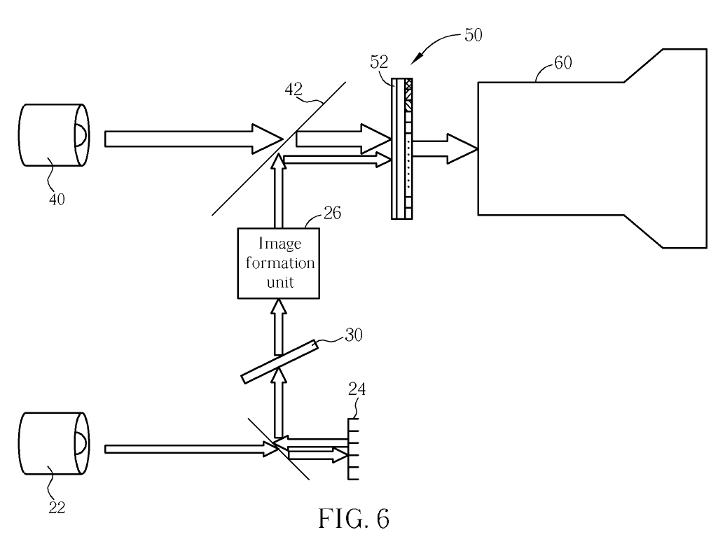

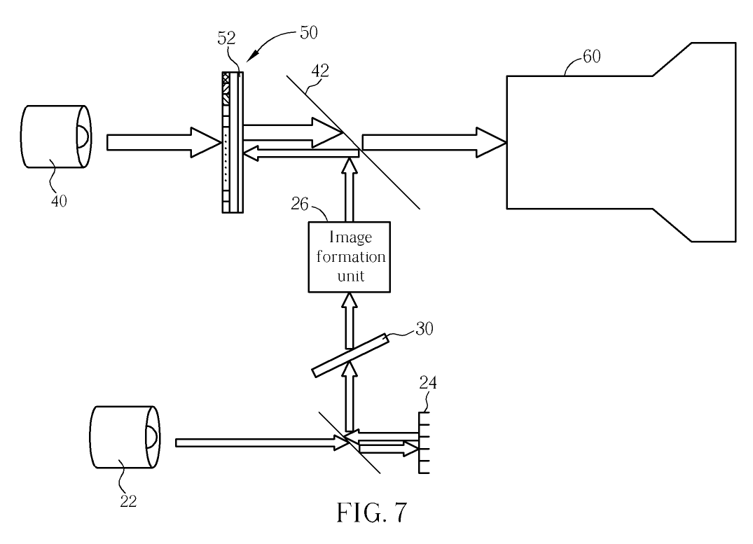

Refer to FIG. 6 and FIG. 7. FIGS. 6 and 7 schematically illustrate projectors according to other embodiments of the present invention. In FIGS. 6 and 7, redundant details are not repeated hereinafter. As shown in FIG. 6, the light synthesizing plane 42 allows the visible light source to penetrate through, and reflects the addressed invisible sub beams. As shown in FIG. 7, the visible light source penetrate through the visible light valve prior to reaching the light synthesizing plane 42, while the addressed invisible sub beams are reflected to the visible light valve 50 by the light synthesizing plane 42.

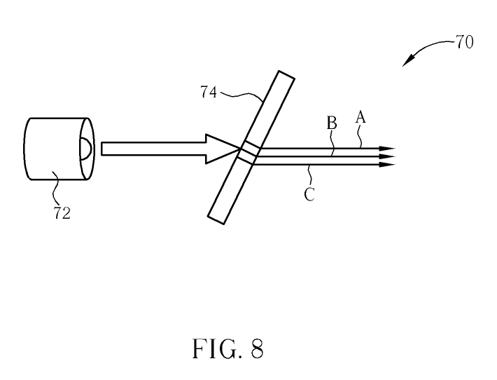

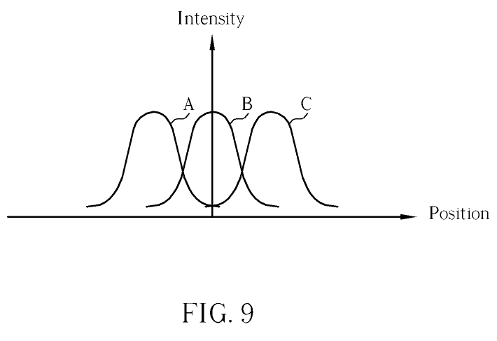

It is appreciated that the application of the sequentially-controlled light shifter is not limited to the aforementioned embodiment. Refer to FIG. 8. FIG. 8 illustrates the sequentially-controlled light shifter when serving as a beam splitter. As shown in FIG. 8, the beam splitter 70 includes a light generator 72 for generating a light source, and a sequentially-controlled light shifter 74 for receiving the light source and sequentially transforming the light source into a plurality of shifted beams. In this embodiment, the light generator 72 is a laser generator, and the sequentially-controlled light shifter 74 is able to solve the speckling issue. Refer to FIG. 9. FIG. 9 is a intensity vs. position relation chart. When the laser source enters the sequentially-controlled light shifter 74, a plurality of shifted laser beams A, B, C will be emitted sequentially. If the time intervals between the shifted laser beams A, B, C is short enough, the intensity of the laser source is equal to the average intensity of the shifted laser beams A, B, C. Therefore, the laser source can be equalized, thereby preventing occurrence of the speckling issue. It is to be noted that the beam splitter is not limited to be incorporated into a laser source, and can be applied to a visible light source within any wavelength range or an invisible light source.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projector, comprising:
an invisible light addressing unit comprising:
an invisible light generator for generating an invisible light source;
an invisible light valve for receiving the invisible light source and transforming the invisible light source into an addressed invisible beam;
a sequentially-controlled light shifter for receiving the addressed invisible beam and sequentially transforming the addressed invisible beam into a plurality of addressed invisible sub beams; and
an image formation unit for forming images of the addressed invisible sub beams;
a visible light generator for generating a visible light source;
a light synthesizing plane for receiving the addressed invisible sub beams sequentially and the visible light source, and sequentially synthesizing the addressed invisible sub beams and the visible light source;
a visible light valve for receiving the addressed invisible sub beams and the visible light source, the visible light valve comprising a plurality of pixel regions, each pixel region comprising a plurality of sub-pixel regions, each sub-pixel region of each pixel region being able to be turned on by each addressed invisible sub beams, so as to allow the visible light source to penetrate through and sequentially form a plurality of visible beams; and
a projection lens for projecting the visible beams.

2. The projector of claim 1, wherein the invisible light valve comprises a DMD chip, an LCOS panel, or an LCD panel.

3. The projector of claim 1, wherein the addressed invisible beams enter the sequentially-controlled light shifter at a non-vertical angle.

4. The projector of claim 1, wherein the sequentially-controlled light shifter comprises a plurality of regions, and the sequentially-controlled light shifter is movable so that the addressed invisible beam sequentially penetrate through different regions and the addressed invisible beam is transformed into the plurality of addressed invisible sub beams with different shifts.

5. The projector of claim 4, wherein the regions have different refraction indexes.

6. The projector of claim 4, wherein the regions have different thicknesses.

7. The projector of claim 4, wherein the sequentially-controlled light shifter is moved rotatably.

8. The projector of claim 4, wherein the sequentially-controlled light shifter is moved to and fro.

9. The projector of claim 4, wherein the light synthesizing plane allows the addressed invisible sub beams to penetrate through, and reflects the visible light source.

10. The projector of claim 4, wherein the light synthesizing plane allows the visible light source to penetrate through, and reflects the addressed invisible sub beams.

11. The projector of claim 1, wherein the visible light valve comprises an LCD panel and an opto-electronic device layer disposed on a surface of the LCD panel.

12. The projector of claim 1, wherein the amount of the sub-pixel regions in each pixel region is equal to or greater than 3.

13. A beam splitter, comprising:
a light source generator for generating a light source; and
a sequentially-controlled light shifter comprising a plurality of regions, wherein the sequentially-controlled light shifter is movable so that the light source sequentially penetrate through different regions and the light source is transformed into a plurality of beams with different shifts.

14. The beam splitter of claim 13, wherein the light source is a visible light source.

15. The beam splitter of claim 14, wherein the visible light source is a laser source.

16. The beam splitter of claim 13, wherein the light source enters the sequentially-controlled light shifter at a non-vertical angle.

17. The beam splitter of claim 13, wherein the regions have different refraction indexes.

18. The beam splitter of claim 13, wherein the regions have different thicknesses.

19. The beam splitter of claim 13, wherein the sequentially-controlled light shifter is moved rotatably.

20. The beam splitter of claim 13, wherein the sequentially-controlled light shifter is moved to and fro.
